(19) United States
(12) Patent Application Publication
(10) Pub. No.: US 2010/0152399 A1
(43) Pub. Date: Jun. 17, 2010

(54) COPOLYMERS AS SCALE INHIBITORS

(75) Inventors: Marcus Guzmann, Muhlhausen (DE); Joachim Pakusch, Speyer (DE); Michael Stösser, Neuhofen (DE); Darijo Mijolovic, Mannheim (DE); Achim Löffler, Speyer (DE); Frank Rittig, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/298,915

(22) PCT Filed: Apr. 26, 2007
(86) PCT No.: PCT/EP07/54091

§ 371 Date: Jun. 9, 2009

(30) Foreign Application Priority Data
May 2, 2006 (EP) 06113377.3

(51) Int. Cl. C08F 226/00

(52) U.S. Cl. 526/173; 526/89; 526/233; 526/274; 526/307.6; 526/307.7

(57) ABSTRACT

The present invention relates to copolymers which are obtainable from the free radical copolymerization of at least (a) a monoethylenically unsaturated carboxylic acid having 3 to 6 carbon atoms or the anhydride thereof with (b) a reaction mixture comprising a component of the general structural formula

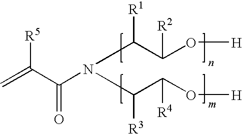

where R¹, R², R³, R⁴, independently of one another, are H or C₁- to C₄-alkyl, n and m, independently of one another, are an integer from 1 to 100 and R⁵ is H or methyl, a process for the preparation of the polymer according to the invention and the use thereof as a scale inhibitor.

For reducing or completely preventing the deposition of sparingly soluble alkaline earth metal salts from aqueous systems, so-called scale inhibitors are employed. These are used in various industrial areas, such as, for example, in boilers for steam generation, in the desalination of seawater by distillation, in the concentration of sugar juice, in washing and cleaning processes, in reverse osmosis and in oil and gas extraction or transport. In the last-mentioned application, for example, sparingly soluble inorganic salts, such as, for example, calcium carbonate, calcium sulfate, barium sulfate and strontium sulfate, may be deposited from the production water and troublesome deposits thus form inside the extraction apparatuses, which deposits may even lead to stoppage of production. This also applies to the transport of the water produced, which was separated from the oil and/or gas extracted. The formation of such deposits is due to changes in the solubility parameters, such as temperature and pressure, during the extraction and the transport or, for example, also as a result of mixing formation water comprising alkaline earth metal ions with a sulfate ion-rich seawater in the formation or inside the extraction apparatuses. Deposits inside the formation impair the permeability of the reservoir and thereby reduce the productivity of oil and gas.

Scale inhibitors used are, for example, polyacrylic acid, polymaleic acid or hydrolyzed water-soluble copolymers of maleic anhydride and, for example, C₂-C₁₂-olefins.

In the case of oil and gas extraction, for example, the scale inhibitor dissolved in water can be injected in an injection or production well or directly into the extraction line by means of a probe in the lower part of the production well or, if appropriate, at a later time within the production process. Polycarboxylates or oligo-/polyphosphates are usually used here. If the scale deposits in the reservoir occur in the inflow region of the production probe, this can be prevented only by a squeeze treatment with a suitable scale inhibitor. In the case of a squeeze treatment, the dissolved scale inhibitor is introduced or forced in excess, virtually as a reserve, directly into the formation in order to be deposited on the formation rock. During the extraction the inhibitor continually detaches from the formation rock. The content of scale inhibitor in water which, for example, is extracted together with oil from the reservoir is checked at certain time intervals. Only when the concentration of scale inhibitor falls below a critical concentration is a further squeeze treatment carried out. Here, it is important to determine the component composition of the production water regularly.

U.S. Pat. No. 4,018,702 discloses the use of reaction products of polymaleic anhydride and compounds comprising amino groups for reducing the deposits described above. Suitable reaction products are, for example, the adducts of iminodiacetate with polymaleic anhydride and the adducts of diethanolamine or ethanolamine with polymaleic anhydride. The efficiency of these products in scale inhibition is, however, in need of improvement.

EP 0 887 316 A1 discloses the use of copolymers, for example of acrylic acid and a substituted acrylamide, and the use thereof as a scale inhibitor.

The publication U.S. Pat. No. 3,880,765 discloses the use of comb polymers which are prepared either by polymer-analogous alkali-initiated ethoxylation of an acrylic acid homo- or copolymer or by copolymerization of acrylic acid ethoxylates with acrylic acid, for preventing deposits in pipelines.

The European laid-open application EP 1 577 372 A1 describes the use of comb polymers having monosubstituted acrylamide-ethoxylate units for the preparation of dispersants from the group consisting of the polycarboxylates for the preparation of aqueous dispersions of particles.

The publication U.S. Pat. No. 4,430,481 describes the preparation of copolymers from acrylamide and acrylamide-diacetone, and the polymer-analogous ethoxylation thereof.

WO-A 97/16464 describes the use of polycarboxylic acid semiamides as scale inhibitors.

EP-B 0 479 465 describes the inhibition of the deposition of barium boiler scale by addition of phosphonates.

As mentioned above, scale inhibitors are used for a very wide range of systems. Common to all these, however, is that the deposition of in particular sparingly soluble alkaline earth metal salts is to be avoided. In this context, the term boiler scale is frequently also used. Here, in particular the precipitation of sulfates and/or carbonates, of the alkaline earth metals calcium, barium and strontium (Ca/Ba/Sr boiler scale) is to be regarded as problematic.

In spite of numerous scale inhibitors which are known in the prior art, there is still a need for improved scale inhibitors which can be used for reducing Ca/Ba/Sr boiler scale deposits.

It is therefore an object of the present invention to provide copolymers having improved properties for reducing Ca/Ba/Sr boiler scale.

This object is achieved by copolymers which are obtainable from the free radical copolymerization of at least
(a) a monoethylenically unsaturated carboxylic acid having 3 to 6 carbon atoms or the anhydride thereof

with
(b) a reaction mixture comprising at least one component of the general structural formula

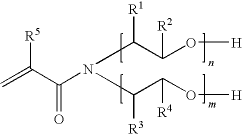

where R¹, R², R³, R⁴, independently of one another, are H or C₁- to C₄-alkyl, such as, for example, methyl, ethyl, isopropyl, n-butyl or n-propyl.

The indices n and m indicate the number of repeating units and as a rule are, independently of one another, an integer in the range from 1 to 500, in particular in the range from 1 to 200, particularly preferably in the range from 2 to 100 and very particularly preferably in the range from 5 to 50. In the context of the present invention, R⁵ is H or methyl.

It was surprisingly found in the course of investigations that the copolymer described above has outstanding properties in the avoidance of Ca/Ba/Sr boiler scale.

Acrylic acid, methacrylic acid and/or maleic anhydride is preferably used as the monoethylenically unsaturated carboxylic acid.

According to a preferred embodiment of the invention, the component of the general structural formula which is present in the reaction mixture (b) is prepared by an alkali-initiated alkoxylation of acrylamide and/or methacrylamide.

The molar ratio of (a) to (b) is preferably in the range from 1:1 to 15:1. The ratio is furthermore preferably in the range from 2:1 to 10:1.

The K value of the copolymers according to the invention is typically from 10 to 100, preferably from 20 to 60, particularly preferably from 30 to 50.

The copolymers according to the invention are obtainable by free radical copolymerization of at least one component (a) and a component (b).

In addition, however, further components may also be used in the copolymers according to the invention in the copolymerization.

These may be, for example, further monoethylenically unsaturated carboxylic acids having 3 to 6 carbon atoms. In addition, further reaction mixtures analogous to component (b) may be used.

However, it is also possible to use components which differ chemically from the components (a) and (b).

It is preferable if the polymers according to the invention are composed only of the components (a) and (b).

If at least one further component is used, it is preferable if this is selected from the starting materials C1 to C7 listed below. Vinylphosphonic acid is very particularly preferably used as a further comonomer for the preparation of the copolymers according to the invention in the free radical copolymerization. The introduction of phosphorus groups advantageously serves for making the copolymers according to the invention more easily quantifiable and detectable.

Thus, the introduction of phosphorus groups permits simple detection, for example with the aid of the molybdenum blue test.

The copolymers according to the invention preferably have an average molar mass M_{w} which is in the range from 200 to 500 000. M_{w} is preferably in the range from 1000 to 200 000, particularly preferably in the range from 2000 to 100 000.

The invention furthermore relates to a process for the preparation of the copolymers according to the invention by means of free radical copolymerization which comprises at least the steps:
i) preparation of at least one reaction mixture comprising at least one component of the abovementioned general structural formula from a preferably alkali-initiated alkoxylation of acrylamide and/or methacrylamide by means of at least one alkylene oxide, and
ii) free radical copolymerization of the at least one reaction mixture obtained in step i) with at least one monoethylenically unsaturated carboxylic acid having 3 to 6 carbon atoms or the anhydride thereof.

The preparation of the at least one reaction mixture from an alkali-initiated alkoxylation of acrylamide and/or methacrylamide by means of an alkylene oxide can be effected in a manner known from the prior art.

According to a preferred embodiment of the invention, process step i) is carried out in the presence of a basic catalyst.

For this purpose, the starting substances are dissolved in a suitable solvent, with addition of a stabilizer and of a catalyst, preferably potassium tert-butylate, and reacted with alkylene oxide per mole of NH function.

Alkylene oxides used are in particular ethylene oxide, propylene oxide, butylene oxide or a mixture of the abovementioned alkylene oxides.

Ranges from 75° C. and 85° C. under a pressure of up to 10 bar have proven to be particularly preferred reaction temperature conditions.

A special procedure of this process for the preparation of the reaction products from an alkali-initiated alkoxylation of (meth)acrylamide consists in first carrying out only a prealkoxylation of the acrylamide and/or methacrylamide in an upstream step.

For the purpose of the prealkoxylation, the acrylamide and/or methacrylamide is reacted only with a portion of the total amount of ethylene oxide used, which corresponds to about 1 mol of ethylene oxide per mole of NH group, or, if the polyalkyleneimine is initially to be modified with up to 2 mol of propylene oxide or butylene oxide per mole of NH group, here too initially only with up to 1 mol of this alkylene oxide.

This reaction is carried out as a rule in the absence of a catalyst at from 50 to 120° C., preferably at from 75 to 85° C., under a pressure of up to 10 bar, in particular up to 8 bar.

In a subsequent second step, the further alkoxylation is then effected by successive reaction with the remaining amount of alkylene oxide.

The alkoxylation is preferably carried out in the presence of a basic catalyst. The basic catalyst in process step i) is preferably selected here from the group consisting of alkali metal and alkaline earth metal hydroxides, such as sodium hydroxide, potassium hydroxide and calcium hydroxide, alkali metal alcoholates, in particular sodium and potassium C₁-C₄-alcoholates, such as sodium methylate, sodium ethylate and potassium tert-butylate, alkali metal and alkaline earth metal hydrides, such as sodium hydride and calcium hydride, and alkali metal carbonates, such as sodium carbonate and potassium carbonate. The alkali metal hydroxides and the alkali metal alcoholates are preferred, potassium hydroxide and sodium hydroxide being particularly preferred.

According to a preferred embodiment of the process, the basic catalyst in process step i) is used in an amount of from 0.05 to 10% by weight, particularly preferably in an amount of from 0.5 to 2% by weight, based on the total amount of acrylamide and/or methacrylamide and alkylene oxide.

A further alkoxylation can be carried out in the absence of a solvent or in an organic solvent.

The process conditions mentioned by way of example below can be used for the ethoxylation and are applicable to the alkoxylations.

With the use of basic catalysts, such as, for example, sodium or potassium hydroxide, the prealkoxylated acrylamide and/or methacrylamide is dehydrated after addition of the catalyst for the formation of the alcoholate. This can be effected in a simple manner under reduced pressure of from 0.01 to 0.5 bar. The subsequent reaction with the alkylene oxide is usually effected at temperatures of from 50 to 120° C., preferably at from 75 to 85° C., under a pressure of up to 10 bar, in particular up to 8 bar, followed in each case by a subsequent stirring time of about 0.5 to 6 hours at a temperature of about 75 to 85° C. and constant pressure.

Particularly suitable reaction media for both processes described above are nonpolar aprotic organic solvents. Aliphatic and aromatic hydrocarbons, such as hexane, cyclohexane, toluene and xylenes, may be mentioned as examples of particularly suitable nonpolar aprotic solvents. Examples of particularly suitable polar, aprotic solvents are ethers, in particular cyclic ethers, such as tetrahydrofuran and dioxane, N,N-dialkylamides, such as dimethylformamide and dimethylacetamide, and N-alkyllactams, such as N-methylpyrrolidone. Furthermore, mixtures of these aprotic solvents may also be used. Particularly preferred solvents for the abovementioned reactions are xylene and toluene.

In addition to the abovementioned starting materials, the reaction mixture to be polymerized in the process according to the invention may also comprise—as already mentioned—further substances differing from the abovementioned starting materials. These include in particular the monoethylenically unsaturated starting materials (starting materials C) listed below. Examples of these are:
C1 monoethylenically unsaturated mono- and dicarboxylic acids having 3 to 8 carbon atoms, such as crotonic acid, isocrotonic acid, maleic acid, fumaric acid and itaconic acid,
C2 alkyl esters of monoethylenically unsaturated mono- and di-C₃-C₈-carboxylic acids, in particular of acrylic acid and of methacrylic acid, with C₁-C₁₀-alkanols or C₃-C₁₀-cycloalkanols, such as methyl acrylate, ethyl acrylate, n-propyl acrylate, isopropyl acrylate, n-butyl acrylate, isobutyl acrylate, tert-butyl acrylate, n-hexyl acrylate, 2-ethylhexyl acrylate, cyclohexyl acrylate and the corresponding methacrylates,
C3 hydroxyalkyl esters of monoethylenically unsaturated mono- and di-C₃-C₈-carboxylic acids, in particular of acrylic acid and of methacrylic acid, such as 2-hydroxyethyl acrylate, 3-hydroxypropyl acrylate, 4-hydroxybutyl acrylate, 2-hydroxyethyl methacrylate, 3-hydroxypropyl methacrylate and 4-hydroxybutyl methacrylate,
C4 monoethylenically unsaturated nitriles, such as acrylonitrile,
C5 vinylaromatic monomers, such as styrene and vinyltoluenes,
C6 monoethylenically unsaturated sulfonic acids and phosphoric acids and salts thereof, in particular alkali metal salts thereof, such as vinylsulfonic acid, allylsulfonic acid, methallylsulfonic acid, styrenesulfonic acid, 2-acryloyloxyethanesulfonic acid, 2-acrylamido-2-methylpropanesulfonic acid, vinylphosphonic acid, allylphosphonic acid, 2-acryloxyethanephosphonic acid, 2-acrylamido-2-methylpropanephosphonic acid, and
C7 monomers carrying amino groups and the protonation products thereof and the quaternization products thereof, such as 2-(N,N-dimethylamino)ethyl acrylate, 2-(N,N-dimethylamino)ethyl methacrylate, 3-(N,N-dimethylamino)propyl acrylate, 2-(N,N-dimethylamino)propyl methacrylate, 2-(N,N,N-trimethylammonium)ethyl acrylate, 2-(N,N,N-trimethylammonium)ethyl methacrylate, 3-(N,N,N-trimethylammonium)propyl acrylate, 2-(N,N,N-trimethylammonium)propyl methacrylate in the form of their chlorides, sulfates and methosulfates.

Preferred additional starting materials are the starting materials C1, C3 and C6. The proportion of monoethylenically unsaturated monomers C1, based on the total amount of the reaction mixture to be polymerized, will as a rule not exceed 30% by weight, and in particular 10% by weight. According to a particularly preferred embodiment no C, or less than 1% by weight of C, based on the total amount of the starting materials to be polymerized, is used.

In addition, for increasing the molecular weight of the copolymer, it may be expedient to carry out the copolymerization in the presence of small amounts of polyethylenically unsaturated monomers having, for example, 2, 3 or 4 polymerizable double bonds (crosslinking agents). Examples of these are diesters and triesters of ethylenically unsaturated carboxylic acids, in particular the bis- and trisacrylates of diols or polyols having 3 or more OH groups, for example the bisacrylates and the bismethacrylates of ethylene glycol, diethylene glycol, triethylene glycol, neopentyl glycol or polyethylene glycols. Such crosslinking agents are, if desired, used in an amount of, as a rule, from 0.01 to 5% by weight, based on the total amount of the monomers to be polymerized. Preferably, less than 0.01% by weight of crosslinker monomers and in particular no crosslinker monomers are used.

The free radical copolymerization according to the invention of at least one reaction mixture obtained in process step i) with acrylic acid and/or methacrylic acid and, if appropriate, further starting materials is usually effected in the presence of compounds forming free radicals, so-called initiators. Such compounds are usually used in amounts of up to 30% by weight, preferably from 0.05 to 15% by weight, in particular from 0.2 to 8% by weight, based on the starting materials to be polymerized. In the case of initiators consisting of a plurality of constituents (initiator systems, e.g. redox initiator systems), the above weight data relate to the sum of the components.

Suitable initiators are, for example, organic peroxides and hydroperoxides, and furthermore peroxodisulfates, percarbonates, peroxoesters, hydrogen peroxide and azo compounds. Examples of such initiators are hydrogen peroxide, dicyclohexyl peroxodicarbonate, diacetyl peroxide, di-tert-butyl peroxide, diamyl peroxide, dioctanoyl peroxide, didecanoyl peroxide, dilauroyl peroxide, dibenzoyl peroxide, bis(o-toluyl)peroxide, succinyl peroxide, methyl ethyl ketone peroxide, di-tert-butyl hydroperoxide, acetylacetone peroxide, butyl peracetate, tert-butyl permaleate, tert-butyl perisobutyrate, tert-butyl perpivalate, tert-butyl peroctanoate, tert-butyl perneodecanoate, tert-butyl perbenzoate, tert-butyl hydroperoxide, cumyl hydroperoxide, tert-amylperpivalate, tert-butoxy-2-ethylhexanoate and diisopropylperoxodicarbamate; and furthermore lithium, sodium, potassium and ammonium peroxodisulfate, azo initiators 2,2′-azobis-isobutyronitrile, 2,2′-azobis(2-methylbutyronitrile), 2,2′-azobis[2-methyl-N-(2-hydroxyethyl)propionamide, 1,1′-azobis(1-cyclohexanecarbonitrile), 2,2′-azobis(2,4-dimethylvaleronitrile), 2,2′-azobis(N,N′-dimethyleneisobutyroamidine)dihydrochloride and 2,2′-azobis(2-amidinopropane)dihydrochloride, and redox initiator systems explained below.

Redox initiator systems comprise at least one peroxide-containing compound in combination with a redox coinitiator, for example a reducing sulfur compound, for example bisulfites, sulfites, thiosulfates, dithionites and tetrathionates of alkali metals or of ammonium compounds. Thus, combinations of peroxodisulfates with alkali metal or ammonium hydrogen sulfites may be used, for example ammonium peroxodisulfate and ammonium disulfite. The amount of peroxide-containing compounds relative to the redox coinitiator is from 30:1 to 0.05:1.

The initiators can be used alone or as a mixture with one another, for example mixtures of hydrogen peroxide and sodium peroxodisulfate.

The initiators may be either water-soluble or insoluble or only slightly soluble in water. For the free radical polymerization in an aqueous medium, water-soluble initiators are preferably used, i.e. initiators which are soluble in the aqueous polymerization medium in the concentration usually used for the polymerization. These include peroxodisulfates, azo initiators having ionic groups, organic hydroperoxides having up to 6 carbon atoms, acetone hydroperoxide, methyl ethyl ketone hydroperoxide and hydrogen peroxide, and the abovementioned redox initiators.

In combination with the initiators or with the redox initiator systems, transition metal catalysts may additionally be used, for example salts of iron, cobalt, nickel, copper, vanadium and manganese. Suitable salts are, for example, iron(I) sulfate, cobalt(II) chloride, nickel(II) sulfate or copper(I) chloride. The reducing transition metal salt is used in a concentration of from 0.1 ppm to 1000 ppm, based on the monomers. Thus, combinations of hydrogen peroxide with iron(II) salts may be used, such as, for example, from 0.5 to 30% of hydrogen peroxide and from 0.1 to 500 ppm of Mohr's salt.

In the free radical copolymerization according to the invention in organic solvents, too, redox coinitiators and/or transition metal catalysts, for example benzoin, dimethylaniline, ascorbic acid and complexes of heavy metals, such as copper, cobalt, iron, manganese, nickel and chromium, which are soluble in organic solvents may be concomitantly used in combination with the abovementioned initiators. The amounts of redox coinitiators or transition metal catalysts usually used are about 0.1 to 1000 ppm, based on the amounts of monomers used.

The free radical copolymerization can also be carried out by the action of ultraviolet radiation, if appropriate in the presence of UV initiators. Such initiators are, for example, compounds such as benzoin and benzoin ether, α-methylbenzoin or α-phenylbenzoin. So-called triplet sensitizers, such as benzyldiketals, may also be used. In addition to high-energy UV lamps, such as carbon arc lamps, mercury vapor lamps or xenon lamps, for example, low-UV light sources, such as fluorescent tubes having a large blue component, also serve as UV radiation sources.

In order to control the average molecular weight of the free radical polymerization in process step ii), it is often expedient to carry out the free radical copolymerization in the presence of regulators. Regulators may be used for this purpose, in particular organic compounds comprising SH groups, in particular water-soluble compounds comprising SH groups, such as 2-mercaptoethanol, 2-mercaptopropanol, 3-mercaptopropionic acid, cysteine, N-acetylcysteine, and furthermore phosphorus(III) or phosphorus(I) compounds, such as alkali metal or alkaline earth metal hypophosphites, for example sodium hypophosphite, and hydrogen sulfites, such as sodium hydrogen sulfite. The polymerization regulators are used in general in amounts of from 0.05 to 10% by weight, in particular from 0.1 to 2% by weight, based on the monomers. Preferred regulators are the abovementioned compounds carrying SH groups, in particular water-soluble compounds carrying SH groups, such as 2-mercaptoethanol, 2-mercaptopropanol, 3-mercaptopropionic acid, cysteine and N-acetylcysteine. In the case of these compounds, it has proven useful to use them in an amount of from 0.05 to 2% by weight, in particular from 0.1 to 1% by weight, based on the monomers. The abovementioned phosphorus(III) and phosphorus(I) compounds and the hydrogen sulfites are usually used in relatively large amounts, for example from 0.5 to 10% by weight and in particular from 1 to 8% by weight, based on the monomers to be polymerized. The average molecular weight can also be influenced by the choice of the suitable solvent. Thus, the polymerization in the presence of diluents having benzylic or allylic H atoms leads to a reduction in the average molecular weight by chain transfer.

According to a further embodiment of the invention, vinylphosphonic acid can be used as a further comonomer in the free radical polymerization in step ii) of the process according to the invention. Both the incorporation of phosphorus groups with the use of hypophosphites as molecular weight regulators and the incorporation of phosphorus groups by using vinylphosphonic acid facilitate the confirmation and the detection of the copolymers according to the invention. In the present case, in particular the molybdenum blue test should be considered as a test method.

In a preferred embodiment, the free radical copolymerization is therefore effected in the presence of a regulator based on a hypophosphite.

The free radical copolymerization of the components of the general structural formula, in particular of reaction products of the alkali-initiated alkoxylation of acrylamide and/or methacrylamide with acrylic acid and/or methacrylic acid, can be effected by the conventional polymerization processes, including solution, precipitation, suspension or mass polymerization. The solution polymerization method, i.e. the polymerization in solvents or diluents, is preferred.

The suitable solvents or diluents include both aprotic solvents, such as, for example, aromatics, such as toluene, o-xylene, p-xylene, cumene, chlorobenzene, ethylbenzene, industrial mixtures of alkylaromatics, aliphatics and cycloaliphatics, such as cyclohexane and industrial aliphatic mixtures, ketones, such as acetone, cyclohexanone and methyl ethyl ketone, ethers, such as tetrahydrofuran, dioxane, diethyl ether and tert-butyl methyl ether, and C₁-C₄-alkyl esters of aliphatic C₁-C₄-carboxylic acids, such as methyl acetate and ethyl acetate, and furthermore protic solvents, such as glycols and glycol derivatives, polyalkylene glycols and derivatives thereof, C₁-C₄-alkanols, e.g. n-propanol, n-butanol, isopropanol, ethanol or methanol, and water and mixtures of water with C₁-C₄-alkanols, such as, for example, isopropanol-water mixtures. The free radical copolymerization process according to the invention is preferably effected in water to a mixture of water with up to 60% by weight of C₁-C₄-alkanols or glycols as solvents or diluents. Particularly preferably, water is used as the sole solvent.

The free radical copolymerization process is preferably carried out in the substantial or complete absence of oxygen, preferably in an inert gas stream, for example a nitrogen stream.

The process according to the invention can be carried out in the apparatuses customary for polymerization methods. These include stirred kettles, stirred kettle cascades, autoclaves, tubular reactors and kneaders. The free radical copolymerization is carried out, for example, in stirred kettles which are equipped with an anchor stirrer, blade stirrer, impeller stirrer or multistage impulse countercurrent agitator. Apparatuses which permit the direct isolation of the solid product after the polymerization, such as, for example, paddle dryers, are particularly suitable. The polymer suspensions obtained can be dried directly in evaporators, such as, for example, belt dryers, paddle dryers, spray dryers or fluidized-bed dryers. However, the main amount of the inert solvent can also be separated off by filtration or centrifuging and, if appropriate, residues of initiators, monomers and protective colloids—if present—can be removed by subsequent washing with fresh solvent and the copolymers dried only thereafter.

The free radical copolymerization is usually effected at temperatures in the range from 0° C. to 300° C., preferably in the range from 40 to 120° C. The duration of the polymerization is usually in the range from 0.5 hour to 15 hours and in particular in the range from 2 to 6 hours. The pressure prevailing in the free radical copolymerization is of minor importance for the success of the polymerization and is as a rule in the range from 800 mbar to 2 bar and frequently ambient pressure. With the use of readily volatile solvents or readily volatile monomers, the pressure may also be higher.

The copolymers obtained with the aid of the process according to the invention typically have K values of from 10 to 100, preferably from 20 to 60. The K values of the copolymers can be determined according to H. Fikentscher, Cellulose-Chemie, Volume 13, 48-64 and 71-74 (1932) in aqueous solution at a pH of 8, a temperature of 25° C. and a polymer concentration of the sodium salt of the copolymers of 1% by weight.

If the process according to the invention is carried out as a solution polymerization in water, removal of the water is not required for many intended uses. Besides, isolation of the copolymers obtainable according to the invention can be carried out in a conventional manner, for example by spray-drying of the polymerization mixture. If the free radical copolymerization is carried out in a steam-containing solvent or solvent mixture, it is possible to remove the solvent by passing in steam, with the result that an aqueous solution or dispersion of the copolymers is obtained.

The copolymers of the free radical copolymerization are preferably obtained in the form of an aqueous dispersion or solution. The solids content is preferably from 10 to 80% by weight, in particular from 20 to 65% by weight.

The copolymers which can be prepared by the process according to the invention are outstandingly suitable in their use as a scale inhibitor for avoiding Ca/Ba/Sr boiler scale and, in this context, serve in particular for inhibiting the precipitation of Ca/Ba/Sr boiler scale. Ca/Ba/Sr boiler scale is caused by at least one of the salts BaSO₄, SrSO₄, BaCO₃ and SrCO₃. Furthermore, other sparingly soluble salts of the alkaline earth metals and, if appropriate, oxides of other metals may be present in the liquid. Such salts are, for example, calcium carbonate, calcium sulfate, calcium silicates, magnesium silicates, magnesium hydroxide and magnesium carbonate and, for example, iron(III) oxide.

In the present invention, avoidance or inhibition of Ca/Ba/Sr boiler scale is present even when the formation of a precipitate of at least one of the salts BaSO₄, SrSO₄, BaCO₃, SrCO₃ is at least partly avoided or retarded.

The copolymers used for preventing Ca/Ba/Sr boiler scale can reduce, retard or prevent the formation of crystals of the abovementioned salts in a liquid, in particular in water-carrying systems. In addition or alternatively, they may also influence the formation of precipitates of such salts. In this way, the liquid environment, for example a boiler, a pipeline, or a pressure container, but also a rock formation or production and/or injection wells for mineral oil or natural gas extraction and storage tanks or apparatuses in oil production, is kept free of precipitates. Precipitates or deposits lead, for example in pipelines, to a reduction in cross section, with the result that the flow-through capacity is reduced. Moreover, the tendency to corrosion, in particular the danger of pitting or crevice corrosion, can be decisively reduced in a particularly advantageous manner by the prevention and/or reduction of precipitates or deposits. With the aid of the polymer according to the invention, the service life of apparatuses or plants can thus be increased. The downtimes and costs for cleaning and procurement of new plant components or apparatuses can be considerably reduced thereby.

The copolymers according to the invention are therefore particularly suitable if the liquid in which the copolymers according to the invention are used is one which comprises water and/or mineral oil and/or natural gas, in particular if the liquid is water.

Furthermore, the liquid environment, such as, for example, a boiler, a pipeline, a pressure container, a rock formation or a production and/or injection well for mineral oil or natural gas extraction, preferably serves for storing, heating or cooling, transporting or extracting the liquid or as a reservoir of the liquid.

The liquid present in the relevant liquid environment comprises the copolymers usually in a substoichiometric amount. Concentrations of up to about 1000 ppm may be customary here. Here, a minimum concentration of the copolymers is typically 0.01 ppm, preferably 0.1 ppm, more preferably 0.5 ppm, in particular 1 ppm, based on the weight of the copolymers and of the liquid. The preferred concentration range of the copolymers in the relevant liquid environment is from 1 to 100 ppm.

In addition to the liquid environments already mentioned above, systems such as a cooling water system, a steam generation system, an aqueous system of a seawater evaporator, an aqueous system of a reverse osmosis apparatus, an aqueous system of a bottle-washing plant, an aqueous system of plants in papermaking, an aqueous system of an evaporation apparatus for sugar production, a soil irrigation system, an aqueous system of a hydrostatic boiler, an aqueous system of a gas-scrubbing plant, an aqueous heating system with closed circulation, a cooling system based on water or an underground water spring system should also be considered.

The temperatures at which the process according to the invention is carried out vary and are determined by the temperature in the well or in the plants. Here, the temperature may be from 0° C. in the case of above-ground plant components to 400° C.

The present invention furthermore relates to the use of the copolymers as a scale inhibitor. Preferred applications of the scale inhibitors to be used according to the invention are the desalination of seawater and brackish water by distillation or membrane processes and, for example, reverse osmosis or electrodialysis. A further application of the scale inhibitors is, for example, in the evaporation of sugar juices from sugar cane and sugarbeet. A further important use as scale inhibitors is in the oil and gas extraction described above and in transport.

The determination of the concentration of the copolymers in the liquid environment can be effected by suitable sampling and subsequent determination of the concentration of the sample. Particularly in relation to oil extraction, the optimum concentration can also be determined by first determining the composition or formation and/or injection water and thus determining the optimum application concentration by methods obvious to the person skilled in the art. Compliance with the concentration thus determined can be checked indirectly by ascertaining that a constant extraction rate is present. Deviation of the extraction rate may be due to Ca/Ba/Sr boiler scale formation.

The copolymers can be metered, for example, at the lower end of a well. A probe can be used for this purpose. The polymer is preferably forced together with the injection water into the rock formation. Furthermore, the polymer is preferably forced into a rock formation through the production well (squeeze treatment).

The following examples are intended to clarify the invention:

A Analysis:

a) Determination of the K Value:
The K values of the aqueous sodium salt solutions of the copolymers were determined according to H. Fikentscher, Cellulose-Chemie, Volume 13, 48-64 and 71-74 (1932) in aqueous solution at a pH of 7, a temperature of 25° C. and a polymer concentration of the sodium salt of the copolymers of 1% by weight.

b) Determination of the Solids Content:
The determination is effected with the aid of the MA30 analysis apparatus from Sartorius. For this purpose, a defined amount of the sample (about 0.5 to 1 g) is weighed into an aluminum dish and dried to constant weight at 90° C. The percentage solids content (SC) is calculated as follows: SC=final weight×100/sample weight [% by weight].

B Alkali-initiated alkoxylation of (meth)acrylamide

### EXAMPLE B1

76.5 g of methylamide were initially taken together with 205 g of dimethylformamide in a 3.5 l jet reactor having jacket cooling, oxide metering and an internal thermometer. 4.35 g of potassium tert-butylate and 1.74 g of a stabilizer, for example phenothiazine or hydroquinone monomethyl ether, were added to this mixture.

Heating to 80° C. was effected under a lean air atmosphere (nitrogen comprising 2% by volume of oxygen) and, at a reaction temperature of 80° C., 50 g of ethylene oxide were first metered in over the course of 15 minutes at a pressure of from 1.5 bar to 2.5 bar. Thereafter, 744.9 g of ethylene oxide were metered at a pressure of up to not more than 8 bar in the course of 3 hours, with a reaction temperature of from 80° C. to 85° C. not being exceeded. The reaction mixture was stirred overnight at 80° C. A final pressure of 2.46 bar was established. This was followed by flushing with nitrogen at a temperature of 80° C. The reactor contents was discharged and the dimethylformamide used was distilled off on a rotary evaporator at not more than 120° C.

928 g of product having a Kaufmann iodine number of 7.8 g of iodine/100 g were obtained.

### EXAMPLE B2

79.9 g of methylamide were initially taken together with 215 g of dimethylformamide in a 2 l jet reactor having jacket cooling, oxide metering and an internal thermometer. 4.54 g of potassium tert-butylate and 1.82 g of a stabilizer, for example phenothiazine or hydroquinone monomethyl ether, were added to this mixture.

Heating to 80° C. was effected under a lean air atmosphere (nitrogen comprising 2% by volume of oxygen) and, at a maximum reaction temperature of 80° C., 50 g of ethylene oxide were first metered in over the course of 15 minutes at a pressure of from 1.5 bar to 2.5 bar. Thereafter, 778.1 g of ethylene oxide were metered at a pressure of up to not more than 8 bar in the course of 5 hours, with a reaction temperature of from 80° C. to 85° C. not being exceeded. This was followed by flushing with nitrogen at a temperature of 80° C. The reactor contents was discharged and the dimethylformamide used was distilled off on a rotary evaporator at not more than 120° C.

941 g of product having a Kaufmann iodine number of 8.0 g of iodine/100 g were obtained.

C Polymerization Process

### POLYMERIZATION EXAMPLE 1

2 g of phosphorous acid and 180 g of water were initially taken in a 1 l glass reactor having an anchor stirrer, thermometer, nitrogen inlet, reflux condenser and a plurality of feed vessels and were heated to 98° C. After this temperature had been reached, the feeds 1, 2 and 3 were then metered in, beginning simultaneously, continuously over a period of 4 hours at constant feed rate while passing in nitrogen and with stirring. Feed 4 is metered in simultaneously with the feeds 1, 2 and 3 at constant feed rate over a period of 5 hours. To complete the polymerization, postpolymerization was then allowed to continue for 1 hour at 98° C. Thereafter, the reaction mixture was cooled to 60° C. and 170.1 g of 50% strength by weight sodium hydroxide solution were added dropwise without exceeding the temperature of 60° C.

The polymer solution obtained was clear and had a solids content of 47.5% and a pH of 6.6. The K value (1% strength by weight in water) was 33.8.

Feed 1: 148.8 g of acrylic acid

Feed 2: 226.2 g of monomer from Example B1
60 g of water

Feed 3: 3.8 g of mercaptoethanol
60 g of water

Feed 4: 10.8 g of sodium peroxodisulfate
75 g of water

### POLYMERIZATION EXAMPLE 2

1.4 g of phosphorous acid and 120 g of water were initially taken in a 1 l glass reactor having an anchor stirrer, thermometer, nitrogen inlet, reflux condenser and a plurality of feed vessels and were heated to 98° C. After this temperature had been reached, the feeds 1, 2 and 3 were then metered in, beginning simultaneously, continuously over a period of 4 hours at constant feed rate while passing in nitrogen and with stirring. Feed 4 is metered in simultaneously with the feeds 1, 2 and 3 at constant feed rate over a period of 5 hours. To complete the polymerization, postpolymerization was then allowed to continue for 1 hour at 98° C. Thereafter, the reaction mixture was cooled to 60° C. and 110 g of 50% strength by weight sodium hydroxide solution were added dropwise without exceeding the temperature of 60° C.

The polymer solution obtained was clear and had a solids content of 47.6% and a pH of 6.7. The K value (1% strength by weight in water) was 45.9.

Feed 1: 99.2 g of acrylic acid

Feed 2: 150.8 g of monomer from Example B1
40 g of water

Feed 3: 1.2 g of mercaptoethanol
40 g of water

Feed 4: 7.2 g of sodium peroxodisulfate
50 g of water

### POLYMERIZATION EXAMPLE 3

1.4 g of phosphorous acid and 120 g of water were initially taken in a 1 l glass reactor having an anchor stirrer, thermometer, nitrogen inlet, reflux condenser and a plurality of feed vessels and were heated to 98° C. After this temperature had been reached, the feeds 1 and 2 were then metered in, beginning simultaneously, continuously over a period of 4 hours at constant feed rate while passing in nitrogen and with stirring. Feed 4 is metered in simultaneously with the feeds 1 and 2 at constant feed rate over a period of 5 hours. To complete the polymerization, postpolymerization was then allowed to continue for 1 hour at 98° C. Thereafter, the reaction mixture was cooled to 60° C. and 64.0 g of 50% strength by weight sodium hydroxide solution were added dropwise without exceeding the temperature of 60° C.

The polymer solution obtained was clear and had a solids content of 48.6% and a pH of 6.9. The K value (1% strength by weight in water) was 34.8.

Feed 1: 56.6 g of acrylic acid

Feed 2: 193.4 g of monomer from Example B2
40 g of water

Feed 3: omitted

Feed 4: 7.2 g of sodium peroxodisulfate
90 g of water

D Testing of performance characteristics of the copolymers from polymerization examples 1 to 3

### USE EXAMPLES

The examples are carried out under the conditions of the Miller Field in the North Sea.

### USE EXAMPLE 1

100 ml of formation water are initially taken in a 250 ml wide-neck glass jar and stirred with a 3 cm long magnetic stirrer bar. This glass jar stands in a waterbath with a magnetic stirrer.

Composition of Formation Water (Miller Field, North Sea):

0.24 g of BaCl₂.2H₂O

6.06 g of SrCl₂.6H₂O

89.40 g of NaCl

52.94 g of CaCl₂.2H₂O

15.06 g of MgCl₂.6 H₂O

dissolved in one liter of demineralized water.

### USE EXAMPLE 2

The amount of copolymer to be investigated is weighed in (taking into account the solids content) into a 100 ml graduated flask and made up to the calibration mark with seawater.

Composition of Seawater:

1.60 g of CaCl₂.2H₂O

11.80 g of MgCl₂.6H₂O

0.02 g of SrCl₂.6H₂O

0.80 g of KCl

4.14 g of Na₂SO₄

0.20 g of NaHCO₃

24.80 g of NaCl

dissolved in one liter of demineralized water.

The graduated flask is adjusted to the measuring temperature in the waterbath.

### USE EXAMPLE 3

Once the two liquids have reached the desired temperature of 80° C. (checking with temperature sensor) the precipitation can be started.

Seawater is added by pouring. The process takes about 5 s. The duration of observation is 50 min.

The following parameters influencing the precipitation are investigated:
polymer concentration
polymers having different chemical composition (in each case as a salt)

Analysis during the precipitation:
Transmittance measurement
   The transmittance is measured using the “662 photometer” scattered light probe from Metrohm. The transmitted light is quantitatively determined. The light source is a tungsten lamp (3.9 watt). The measurements are carried out at 450 nm.
Temperature measurement
   The temperature measurement is effected by means of temperature sensor PT100. The measured values are read in by the pH meter from Knick Calimac.
pH measurement
   The pH measurement is effected by means of a 765 pH meter from Knick Calimac. pH electrode: Aquatrode Plus; the measured values are read in via the pH meter 765 from Knick Calimac.

The experimental results of the turbidimetric measurement are listed in the following table (% transmittance after 50 min, measurements at 80° C.). At the beginning of the measurement, at time 0 second, all samples had a transmittance of 100%.

| | Dose | | | | | |
|---|---|---|---|---|---|---|
| | 0 ppm | 1 ppm | 5 ppm | 10 ppm | 20 ppm | 50 ppm |
| Polymerization | 8.9 | 23 | 79.3 | 99.8 | 99.8 | 99.9 |
| example A | | | | | | |
| Polymerization | 8.9 | 9.9 | 57.1 | 93.7 | 99.5 | 99.5 |
| example B | | | | | | |

In the present invention inhibition of the precipitation of Ca/Ba/Sr boiler scale (avoidance of Ca/Ba/Sr boiler scale) is present preferably when the transmittance value is at least 50%, more preferably at least 75%, even more preferably at least 90%, even more preferably at least 95%, in particular at least 98%, after 3000 seconds.

1. A copolymer obtainable from the free radical copolymerization of at least
(a) an ethylenically unsaturated carboxylic acid having 3 to 6 carbon atoms or the anhydride thereof
with
(b) a reaction mixture comprising at least one component of the general structural formula 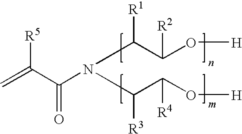
where R¹, R², R³, R⁴, independently of one another, are H or C₁- to C₄-alkyl, n and m, independently of one another, are an integer from 5 to 50 and R⁵ is H or methyl.

2. The copolymer according to claim 1, the monoethylenically unsaturated carboxylic acid being acrylic acid, methacrylic acid and/or maleic anhydride.

3. (canceled)

4. The copolymer according to claim 1, the molar ratio of (a) to (b) being from 1:1 to 15:1.

5. The copolymer according to claim 1, with the K value being from 10 to 100.

6. The copolymer according to claim 1, vinylphosphonic acid being used as a further comonomer in the free radical copolymerization.

7. The copolymer according to claim 1, the free radical copolymerization being effected in the presence of a regulator based on a hypophosphite.

8. A process for the preparation of copolymers according to claim 1, comprising the steps:
i) preparation of at least one reaction mixture comprising at least one component of the general structural formula according to claim 1 from a alkali-initiated alkoxylation of acrylamide and/or methacrylamide by means of at least one alkylene oxide, and
ii) free radical copolymerization of at least one of the reaction mixtures obtained in step i) with at least one monoethylenically unsaturated carboxylic acid having 3 to 6 carbon atoms or the anhydride thereof.

9. The process according to claim 8, the alkylene oxide in process step i) being selected from the group consisting of ethylene oxide, propylene oxide, butylene oxide and a mixture thereof.

10. The process according to claim 8, process step i) being carried out in the presence of a basic catalyst.

11. The process according to claim 10, the basic catalyst in process step i) being selected from the group consisting of alkali metal and alkaline earth metal hydroxides, such as sodium hydroxide, potassium hydroxide and calcium hydroxide, alkali metal alcoholates, in particular sodium and potassium C₁-C₄-alcoholates, such as sodium methylate, sodium ethylate and potassium tert-butylate, alkali metal and alkaline earth metal hydrides, such as sodium hydride and calcium hydride, and alkali metal carbonates, such as sodium carbonate and potassium carbonate.

12. The process according to claim 10, the basic catalyst in process step i) being used in an amount of from 0.05 to 10% by weight, based on the total amount of the starting materials.

13. The process according to claim 8, the free radical copolymerization in step ii) being carried out in the presence of a molecular weight regulator.

14. The process according to claim 13, the molecular weight regulator in step ii) being used in an amount of from 0.05 to 10% by weight, based on the total amount of the starting materials to be polymerized.

15. The process according to claim 13, the molecular weight regulator being based on a hypophosphite.

16. The process according to claim 8, vinylphosphonic acid being used as a further comonomer in step ii) in the free radical polymerization.

17. The method of the copolymers according to claim 1, as a scale inhibitor.

18. The method of the copolymers according to claim 17 in oil field applications.

19. The copolymer according to claim 1, the monoethylenically unsaturated carboxylic acid being acrylic acid, methacrylic acid or maleic anhydride.

20. The copolymer according to claim 1, the component of the general structural formula which is present in the reaction mixture (b) being prepared by an alkali-initiated alkoxylation of acrylamide and methacrylamide.

21. The copolymer according to claim 1, the component of the general structural formula which is present in the reaction mixture (b) being prepared by an alkali-initiated alkoxylation of acrylamide or methacrylamide.
